(19) United States
(12) Patent Application Publication
(10) Pub. No.: US 2010/0272551 A1
(43) Pub. Date: Oct. 28, 2010

(54) POWDER/GRANULAR MATERIAL FEEDER

(76) Inventors: Kenichi Kumashiro, Osaka (JP); Takashi Shima, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/746,935

(22) PCT Filed: Dec. 21, 2007
(86) PCT No.: PCT/JP2007/074735

§ 371 Date: Jun. 9, 2010

(51) Int. Cl. B65G 65/46; B65G 65/40

(52) U.S. Cl. 414/787

(57) ABSTRACT

A powder/granular material feeder is provided which can prevent bridges and rat holes, which makes a hopper less likely to vibrate, and which can be easily cleaned.

The powder/granular material feeder includes a hopper 1 for storing powder/granular material, and a screw conveyor 2 provided at the lower end of the hopper 1 for feeding powder/granular material in the hopper 1 to the next step, wherein the hopper 1 is a conical member having a downwardly decreasing diameter, and is made of a soft material, and wherein the powder/granular material feeder further includes rollers 3 and 4 in contact with the outer peripheral surface of the hopper 1, a ring member 5 provided coaxially with the hopper 1 and supporting the rollers 3 and 4, and a motor 8 for rotating the ring member 5. With this arrangement, since the deflected positions of the hopper 1 caused by the contact with the rollers 3 and 4 continuously move in the circumferential direction when the ring member 5 rotates, the powder/granular material in the hopper (1) rotates. As a result, bridges and rat holes are less likely to form.

### TECHNICAL FIELD

The present invention relates to a powder/granular material feeder for feeding powder/granular material.

### BACKGROUND ART

In the case of quantitatively feeding powder/granular material such as flour, corn starch, medicine, chemical fertilizer, resin pellets, cement or the like, a powder/granular material feeder is frequently used. The powder/granular material feeder includes a hopper for storing powder/granular material, and a discharge apparatus connected to the lower end of the hopper, and is structured to feed the powder/granular material in the hopper to the next step by the discharge apparatus.

In the powder/granular material feeder, since the feed rate of the powder/granular material to the next step is equal to the decreasing amount of a total weight of the hopper and the discharge apparatus, it is possible to increase the feed precision of the powder/granular material by installing a measuring device for detecting the total weight of the hopper and the discharge apparatus and controlling the discharge apparatus based on a detection signal of the measuring device.

Control of the discharge apparatus carried out based on the detection signal of the measuring device includes a continuous operation control in which the discharge apparatus is continuously operated while controlling the transportation speed of the discharge apparatus in such a manner that the feed rate of the powder/granular material per unit time becomes constant, and a batch operation control in which the discharge apparatus is intermittently operated while controlling the timing for switching actuation and stop of the discharge apparatus in such a manner that the powder/granular material is fed by a fixed amount (batch).

The powder/granular material feeder mentioned above has a problem in that if a bridge (arch shaped lump of the powder/granular material) or a rat hole (cavity extending vertically through the powder/granular material) forms in the powder/granular material within the hopper, the powder/granular material within the hopper may be not be fed to the next step, even though powder/granular material remains in the hopper.

Accordingly, in order to prevent such bridges and rat holes, there have been proposed a powder/granular material feeder in which a vibration generating apparatus is attached to the wall surface of the hopper (Patent Document 1), and a powder/granular material feeder including a hopper made of a soft material, and an oscillating plate provided outside the hopper and oscillated by a link mechanism such that one and the other ends of the oscillating plate alternately come into contact with the wall surface of the hopper (Patent Document 2).

The powder/granular material feeder described in Patent Document 1 vibrates the wall surface of the hopper by the vibration generating apparatus, and prevents bridges and rat holes based on the vibration transmitted to the powder/granular material from the wall surface. Further, the powder/granular material feeder described in Patent Document 2 makes the powder/granular material within the hopper flow toward the center of the hopper based on deflection of the hopper when the oscillating plate comes into contact with the wall surface of the hopper, and prevents bridges and rat holes based on the flow.

However, in the powder/granular material feeder described in Patent Document 1, since the hopper vibrates, a detection signal of the measuring device for detecting the total weight of the hopper and the discharge apparatus tends to be unstable if such a measuring device is used. Accordingly, it is difficult to stabilize the feed precision of the powder/granular material when controlling the discharge apparatus based on the detection signal of the measuring device. In the powder/granular material feeder described in Patent Document 2, since the hopper vibrates by a shock when the oscillating plate comes into contact with the wall surface of the hopper, the detection signal of the measuring device tends to be unstable.

Further, there has been known a powder/granular material feeder structured such that an agitating member is provided within a hopper, and the agitating member is rotated to prevent bridges and rat holes (Patent Document 3). Since the powder/granular material feeder directly agitates the powder/granular material within the hopper and not through the wall surface of the hopper, the hopper is less likely to vibrate. Accordingly, in the case of installing the measuring device for detecting the total weight of the hopper and the discharge apparatus, the detection signal of the measuring device tends to be stable.

However, in this powder/granular material feeder, there is a case that powder/granular material attached to the agitating member grows into a lump when the agitating member rotates, and movement of the powder/granular material from the hopper to the discharge apparatus is prevented due to the lump of the powder/granular material. Further, in this powder/granular material feeder, the agitating member forms an obstacle when cleaning the interior of the hopper. Further, it is necessary to clean the agitating member in addition to the hopper. This increases the number of portions to be cleaned.

Patent Document 1: Japanese Unexamined Patent Publication No. 2004-51339 (FIG. 3)

Patent Document 2: Japanese Unexamined Utility Model Publication No. 58-45234

Patent Document 3: Japanese Unexamined Patent Publication No. 6-32458

### DISCLOSURE OF THE INVENTION

### Object of the Invention

An object of the present invention is to provide a powder/granular material feeder which can prevent bridges and rat holes, which makes a hopper less likely to vibrate, and which can be easily cleaned.

### Means for Achieving the Object

In order to achieve this object, the powder/granular material feeder according to the present invention includes a hopper which is a conical member having a downwardly decreasing diameter, and made of a soft material, and further comprises at least one roller in contact with the outer peripheral surface of the hopper, a ring member provided coaxially with the hopper and supporting the roller, and a motor for rotating the ring member. Preferably, there are provided a plurality of the rollers arranged so as to be spaced from each other in the circumferential direction.

Further, the present invention further provides a powder/granular material feeder which is further provided with a measuring device for detecting the total weight of the hopper and the discharge apparatus, and a controller for controlling the discharge apparatus based on a detection signal of the measuring device.

### EFFECTS OF THE INVENTION

In the powder/granular material feeder according to this invention, the hopper is radially inwardly deflected by contact of the hopper with the roller. When the ring member rotates, the deflected portion of the hopper continuously moves in the circumferential direction. At this time, since the powder/granular material is the hopper is pushed by the inner peripheral surface of the hopper so as to flow in the circumferential direction, and the powder/granular material in the hopper rotates as a whole due to this flow, bridges and rat hole are less likely to form.

Further, since the powder/granular material feeder prevents bridges and rat holes based on the continuous movement of the deflected position of the hopper, the hopper is less likely to vibrate.

Further, in the powder/granular material feeder, since there is no agitating member in the hopper, there is no problem that powder/granular material attached to the agitating member grows into a lump, so that the powder/granular material can be smoothly moved from the hopper to the discharge apparatus.

Further, in the powder/granular material feeder, since there is no agitating member in the hopper, cleaning is easy.

Further, in the structure in which the plurality of the rollers are provided so as to be spaced in the circumferential direction, since the forces in the radial direction acting on the hopper from the respective rollers cancel each other, the center position of the hopper becomes stable, and it is possible to effectively prevent the vibration of the hopper.

### BRIEF DESCRIPTION OF THE DRAWINGS

FIG. 1 is a sectional view of a powder/granular material feeder according to an embodiment of this invention.

FIG. 2 is a sectional view taken along line II-II of FIG. 1.

FIG. 3(a) is a perspective view of a portion of a ring member of the powder/granular material feeder shown in FIG. 1; and FIG. 3(b) is a perspective view of a portion of a hopper and a screw conveyor of the powder/granular material feeder shown in FIG. 1.

FIG. 4 is a perspective view showing a used state of the powder/granular material feeder shown in FIG. 1.

### DESCRIPTION OF REFERENCE NUMERALS

1 hopper
2 screw conveyor
3, 4 roller
5 ring member
8 motor
15 measuring device
16 controller

### BEST MODE FOR CARRYING OUT THE INVENTION

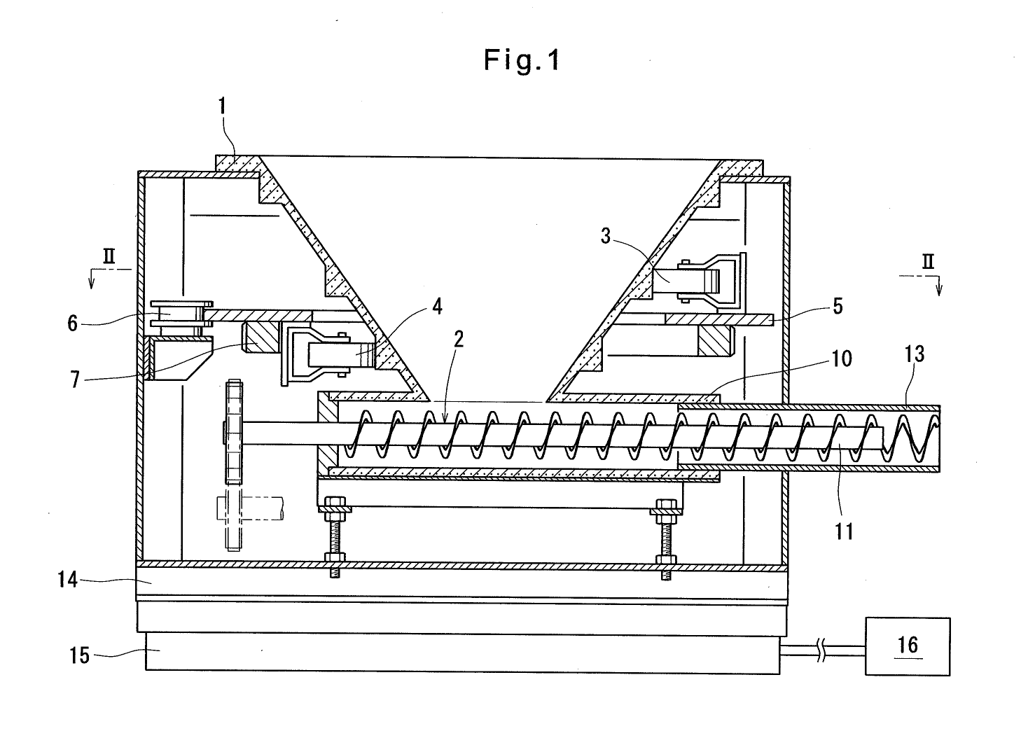

FIG. 1 shows a powder/granular material feeder according to an embodiment of this invention. This powder/granular material feeder has a hopper 1 for storing powder/granular material, and a screw conveyor 2 provided at the lower end of the hopper 1, and feeds the powder/granular material within the hopper 1 to the next step by the screw conveyor 2.

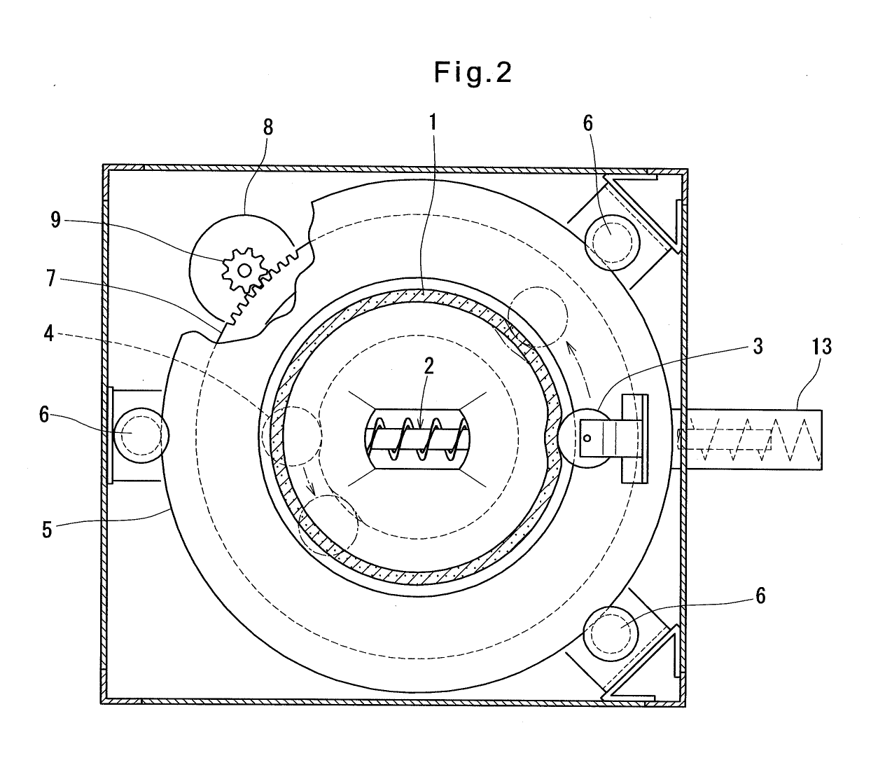

The hopper 1 is a conical member having a downwardly decreasing diameter, and made of a soft material. As the soft material, for example, a rubber material such as polyethylene rubber, neoprene rubber, or silicone rubber, or a thermoplastic elastomer can be used. Rollers 3 and 4 are kept in contact with the outer peripheral surface of the hopper 1. The rollers 3 and 4 are attached to a ring member 5 made of a hard material (e.g., metal, or plastic) so as to be spaced in the circumferential direction, and the hopper 1 is pressed and deflected radially inwardly by the rollers 3 and 4 (see FIG. 2).

As shown in FIG. 2, the ring member 5 is rotatably supported by a guide member 6, and is held at a coaxial position with the hopper 1. A ring gear 7 is coaxially fixed to the ring member 5. The ring gear 7 meshes with a drive gear 9 connected to a motor 8. Thus, when the motor 8 is rotated, its rotation is transmitted to the ring member 5, and the ring member 5 is rotated.

As shown in FIG. 1, the outer peripheral surface of the hopper 1 is formed into a cylindrical shape at its portion that is in contact with the rollers 3 and 4 so that the rollers 3 and 4 smoothly roll when the ring member 5 is rotated.

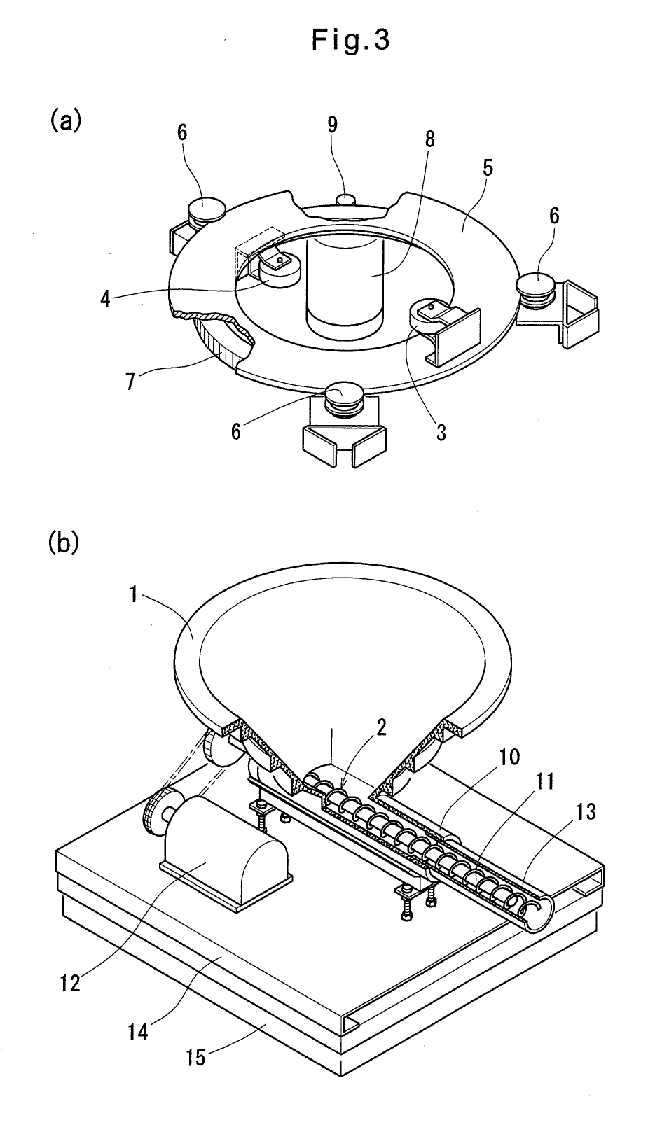

The screw conveyor 2 has a tubular casing 10 formed integrally with the hopper 1, a screw shaft 11 inserted through the casing 10, and a motor 12 (see FIG. 3(b)) for rotating the screw shaft 11.

As shown in FIG. 3(b), the casing 10 communicates with the lower end of the hopper 1, and is structured such that when powder/granular material is put in the hopper 1, the powder/granular material flows into the casing 10 through the lower end of the hopper 1. The powder/granular material flowing into the casing 10 moves within the casing 10 based on the rotation of the screw shaft 11, passes through a metal sleeve 13 fitted to an open end of the casing 10, and is discharged to the next step.

The hopper 1 and the screw conveyor 2 are supported by a pedestal 14. The pedestal 14 is mounted on a measuring device 15, so that the total weight of the hopper 1 and the screw conveyor 2 is detected by the measuring device 15. The measuring device 15 is connected to a controller 16 (see FIG. 1) for controlling the screw conveyor 2, and is structured such as to transmit a detection signal corresponding to the total weight of the hopper 1 and the screw conveyor 2 to the controller 16.

The controller 16 controls the screw conveyor 2 based on the detection signal transmitted from the measuring device 15. The control of the screw conveyor 2 may be a continuous operation control in which the screw shaft 11 is continuously rotated while controlling the rotating speed thereof in such a manner that the feed amount of the powder/granular material per unit time (that is, the decreasing amount of the total weight of the hopper 1 and the screw conveyor 2 per unit time) becomes constant, or a batch operation control in which the screw shaft 11 is intermittently rotated while controlling the timing for switching on and off of the rotation of screw shaft 11 in such a manner that the powder/granular material is fed by a fixed amount (batch).

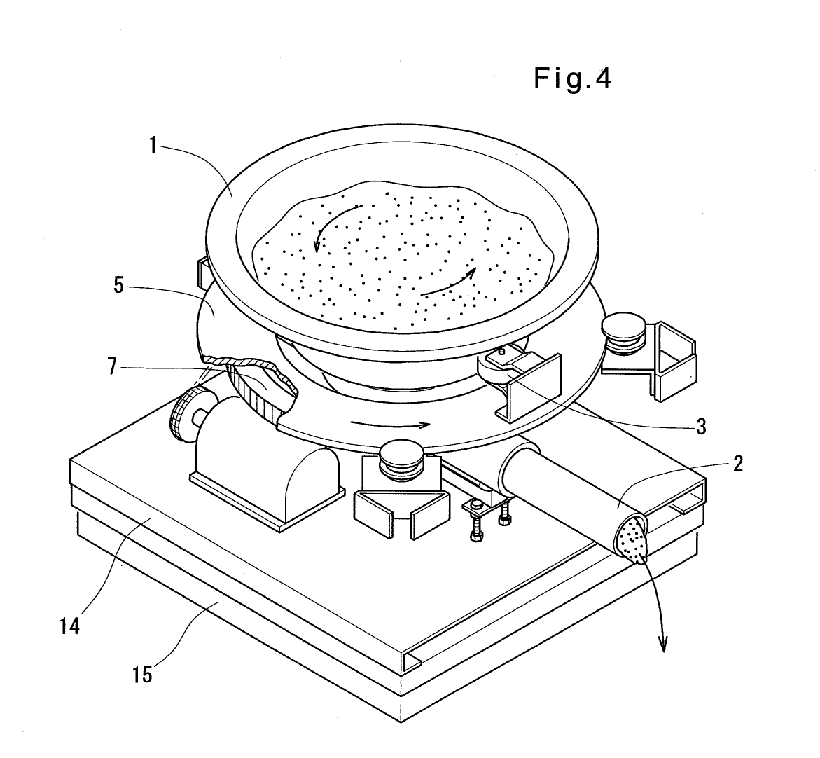

With this powder/granular material feeder, the screw conveyor 2 is actuated with ring member 5 rotating, thereby discharging powder/granular material in the hopper 1 to outside by means of the screw conveyor 2, as shown in FIG. 4. At this time, since each of the deflected positions of the hopper 1 due to contact with the rollers 3 and 4 continuously moves in the circumferential direction as shown by a chain line in FIG. 2, the powder/granular material in the hopper 1 is pushed by the inner peripheral surface of the hopper 1 so as to flow in the circumferential direction, and due to this flow, the powder/granular material in the hopper 1 rotates as a whole and flows like an eddy current. As a result, lumps are less likely to form in the powder/granular material in the hopper 1, and bridges and rat holes are prevented. Further, since the powder/granular material in the hopper 1 flows like an eddy current into the lower end of the hopper 1, the powder/granular material smoothly moves from the hopper 1 into the screw conveyor 2.

Since the powder/granular material feeder prevents bridges and rat holes based on the continuous movement of the deflected positions of the hopper 1, the hopper 1 is less likely to vibrate. Accordingly, the measurement value of the measuring device 15 becomes stable, and it is possible to feed powder/granular material at a high precision.

Further, since there are a plurality of the rollers 3 and 4 arranged so as to be spaced in the circumferential direction in the powder/granular material feeder, the forces in the radially direction acting on the hopper 1 from the respective rollers 3 and 4 cancel each other. Accordingly, the center position of the hopper 1 becomes stable, and the hopper 1 is less likely to vibrate even when the ring member 5 is rotated at a high speed.

Further, since there is no agitating member in the hopper 1 of the powder/granular material feeder, there is no problem that powder/granular material attached to the agitating member grows into a lump, so that powder/granular material can be smoothly moved from the hopper 1 into the screw conveyor 2.

Further, since there is no agitating member in the hopper 1 of the powder/granular material feeder, the cleaning work is easily carried out.

Further, it is not necessary to provide a link mechanism and the number of parts is small, in the powder/granular material feeder, compared to the powder/granular material feeder including the oscillating plate provided outside the hopper and oscillated by the link mechanism to prevent bridges and rat holes. Accordingly, a low cost is achieved.

In the embodiment mentioned above, the casing 10 is formed integrally with the hopper 1. But the casing 10 may be made of metal and be independent from the hopper 1, and the casing 10 may be fixed to the hopper 1. In this case, the casing 10 may be fixed, for example, by forming a flange on the outer periphery of the hopper 1 at its lower end, and fastening the flange and the casing 10 by bolts and nuts.

Further, in the embodiment mentioned above, two rollers 3 and 4 are attached to the ring member 5. But three or more rollers coming into contact with the outer periphery of the hopper 1 may be attached so as to be spaced in the circumferential direction.

In the embodiment mentioned above, the screw conveyor 2 is employed as the discharge apparatus connected to the lower end of the hopper 1 in order to improve the feed precision of the powder/granular material. But instead of the screw conveyor 2, the discharge apparatus connected to the lower end of the hopper 1 may be a belt conveyor or a rotary valve (valve comprising a horizontal cylindrical casing and an impeller and adapted to deliver powder/granular material on the upper side of the impeller to the lower side thereof by rotating the impeller).

1-3. (canceled)

4. A bulk material feeder comprising:
a hopper (1) for reserving a bulk material;
a discharge apparatus (2) continuously provided in a lower end of the hopper (1); and
the discharge apparatus (2) for feeding the bulk material within the hopper (1) to the next step, wherein
the hopper (1) is formed into a downwardly diameter reduced conical shape, the hopper (1) is formed by a soft material, a cylindrical outer peripheral surface around an axis of the hopper (1) is formed in an outer periphery of a portion having a conical inner peripheral surface of the hopper (1), rollers (3, 4) which are in parallel to the axis of the hopper (1) are brought into contact with the outer peripheral surface, the rollers (3, 4) are attached to a ring member (5) which is provided coaxially with the hopper (1), and a motor (8) for rotationally driving the ring member (5) is provided.

5. The bulk material feeder according to claim 4, wherein the rollers (3, 4) are plurally provided so as to be spaced in a peripheral direction.

6. The bulk material feeder according to claim 5, further comprising a measuring device (15) for detecting a total weight of the hopper (1) and the discharge apparatus (2), and a controller (16) for controlling the discharge apparatus (2) based on a detection signal of the measuring device (15).

7. The bulk material feeder according to claim 4, further comprising a measuring device (15) for detecting a total weight of the hopper (1) and the discharge apparatus (2), and a controller (16) for controlling the discharge apparatus (2) based on a detection signal of the measuring device (15).
